(19) United States
(12) Patent Application Publication
(10) Pub. No.: US 2025/0121445 A1
(43) Pub. Date: Apr. 17, 2025

(54) Device and Method for Plasma-Electrolytic Machining of the Electrically Conductive Surface of a Workpiece by Electrolyte Jets

(71) Applicant: Technische Universität Bergakademie Freiberg, Freiberg (DE)

(72) Inventors: Vincent Stepputat, Freiberg (DE); Michael Penzel, Freiberg (DE); Sam Schröder, Freiberg (DE); Henning Zeidler, Freiberg (DE)

(21) Appl. No.: 18/571,272

(22) PCT Filed: Jun. 30, 2023
(86) PCT No.: PCT/EP2023/068123

§ 371 Date: Dec. 18, 2023

(30) Foreign Application Priority Data
Jul. 1, 2022 (EP) 22182699.3

(51) Int. Cl. B23H 3/10; B23H 3/02

(52) U.S. Cl. CPC B23H 3/10; B23H 3/02

(57) ABSTRACT

A device (1) and a method for plasma-electrolytic machining of an electrically conductive surface (2) of a workpiece (3) are described. The device has an application unit (4) for applying an electrolyte jet to the surface (2), a supply unit (5) for at least temporarily supplying the application unit (4) with the electrolyte required to generate the electrolyte jet, at least one electrode (6), which forms a counter-electrode to the surface (2) during machining, and at least one electrical energy source (7), using which the electrode and the surface can be supplied with electrical energy during machining, such that a current flows between the electrode (6) and the surface (2) to be machined upon contact with the electrolyte.

The technical solution described is characterized in that the application unit (4) is designed to apply a first and at least one second electrolyte jet, which have different jet effect areas on the surface to be machined, simultaneously or consecutively to the surface (2) of the workpiece (3).

### CROSS REFERENCE TO RELATED APPLICATIONS

This application is the U.S. national stage of International Application No. PCT/EP2023/068123, filed on 2023 Jun. 30. The international application claims the priority of EP 22182699.3 filed on 2022 Jul. 1; all applications are incorporated by reference herein in their entirety.

### BACKGROUND

The invention relates to a device and a method for plasma-electrolytic machining of an electrically conductive surface of a workpiece. For that, the device has an application unit for applying an electrolyte jet to the workpiece surface, a supply unit for at least temporarily supplying the application unit with the electrolyte required to generate the electrolyte jet, and at least one electrode, which forms a counter-electrode to the surface as a cathode during machining. To produce the required voltage, at least one voltage source is also provided, using which a voltage can be applied between the electrode and the surface to be machined, which are each at least partially in contact with the electrolyte, during the machining of the workpiece surface.

For workpieces made of metal alloys, the target characteristics of the surface are frequently not achieved in the primary production step, so that downstream finishing or refinement, resp., is required. This comprises, for example, polishing, cleaning, sterilizing, texturing and coating of the surface as well as deburring and rounding of workpiece edges. In that, in particular methods changing the surface characteristics by removing material are of considerable economic and technological importance. The finishing of metal surfaces by machining methods with geometrically undefined cutting edges, such as grinding or mechanical polishing, which enable low roughness and high gloss, is well known. These methods always require the surface to be reachable by a tool that is usually rotating, so that the machining of narrow, concave contours and inner surfaces is hardly feasible. In addition, the process principle always requires precise coordination of the relative position of the tool to the machined surface. Changes to the target contour, e.g., due to changing or customizable workpieces, require complex adjustments to the NC program with automated process control, which considerably limits flexibility. If, on the other hand, it is carried out manually, very long machining times of approx. 20 minutes can be expected for complex components. In addition, reproducibility is considerably limited, as the results always depend on the individual skills of the employees, and health risks from grinding dust are to be expected. In contrast, the likewise known methods for electrochemical polishing, in particular electropolishing and electrochemical ablation, are characterized by force-free material removal. In electrochemical metalworking, the workpieces are processed by anodic dissolution of the metal on the surface. Corresponding methods are used in various areas of mechanical engineering, such as aerospace technology, vehicle construction, toolmaking in medical and microsystems technology as well as in energy plant construction. Almost all metals can be processed in this manner, as the process is not negatively influenced by high strength or hardness, unlike machining. In this respect, electrochemical machining is particularly interesting for high-alloy materials, such as nickel-based alloys, titanium alloys or hardened materials. Depending on the method selected, problems can arise due to the electrolytes used or the highly concentrated, hot mineral acids sometimes used, which lead to heavy material removal and rapid edge rounding. In addition, the achievable roughness and the achievable gloss are only in the medium requirement range, wherein roughness values Ra of 0.2 μm can typically be achieved. This disqualifies the methods especially for decorative and functional applications that require a high gloss level of the surface.

Plasma-electrolytic machining of electrically conductive surfaces represents a special further development of the known methods for electrochemical machining of metallic workpieces. Plasma-electrolytic machining processes are methods, by which the condition of a workpiece surface, that is at least temporarily in contact with an electrolyte, is changed by applying an electrical voltage, wherein this change is made possible, favored or influenced by the formation of a plasma close to the surface. While plasma-electrolytic oxidation, among others, serves to produce wear-resistant boundary layers, particularly on light metals, plasma-electrolytic polishing changes the boundary layer by removing material. Compared to electropolishing, this is done using aqueous saline solutions instead of highly concentrated acids as the electrolyte, wherein the workpiece is typically immersed into such an electrolyte bath and anodically contacted. By applying a DC voltage of 200 V to 450 V, preferably 230 V to 350 V, the electrolyte in contact with the workpiece evaporates and forms a vapor skin surrounding it, which displaces the electrolyte solution from the workpiece surface. The polishing voltage dropping across the vapor skin leads to partial ionization and the formation of a plasma. The surface of the workpiece is evenly smoothed by a combination of physical, chemical and electrochemical removal processes and simultaneously freed from impurities. In this manner, particularly smooth and shiny surfaces can be produced in a very short time and without the need for forming tools. In addition, it is not necessary to pre-treat the respective workpiece or remove any oils or lubricants possibly present on the surface. Furthermore, depending on the material being processed, plasma-electrolytic machining can produce a workpiece surface, the corrosion tendency of which is inhibited. The method is therefore not only suitable for reducing surface roughness, but also, among others, for deburring, creating a shine, passivating, cleaning, sterilizing as well as smoothing of the surface profile.

A generic system for plasma polishing is known from DE 10 2006 016 368 B4. The system described is suitable for cleaning and polishing electrically conductive workpiece surfaces and has an electrolyte container, a holder for the workpiece and a power supply for providing the voltage required for plasma-electrolytic machining. Furthermore, a control unit for monitoring and setting the required current intensity is provided, which adjusts the current intensity depending on the speed at which the workpiece is immersed into the electrolyte container.

The known methods for plasma-electrolytic treatment of electrically conductive surfaces, which use an electrolyte bath, have decisive limitations with regard to the workpiece geometry that can be machined. Firstly, stable process control requires that the gas bubbles forming and rising can flow along the workpiece contour in the form of a uniform vapor skin. This is regularly not the case with complex components, especially on highly concave surfaces or contour-deepening structures with a high aspect ratio, e.g., boreholes, cavities and drawn profiles with a small contour distance. Then there is no stable material removal typical for the method, meaning that in these cases, plasma-electrolytic machining is often not suitable for industrial processes.

A further disadvantage is that the required current intensity must be provided in proportion to the component surface, as the underlying operating principle requires a material- and electrolyte-specific current density on the workpiece surface, which is typically in the range of 0.2 A/cm² to 0.5 A/cm². Depending on the power available for a machining system in an average industrial plant, the method is thus subject to a technological and economic limit in terms of component size, which rarely exceeds the dimensions of a cube with an edge length of 20 cm. In addition, the use of plasma-electrolytic machining processes for large components, which require large machining systems, is often uneconomical. This especially applies, if only individual surfaces or contours are to be machined, such as for deburring, instead of the entire component surface. The machining of the entire surface inherent in plasma-electrolytic polishing in the electrolyte bath then regularly leads to a multiple of the power requirement, the investment requirement and the machining effort than would be necessary to fulfill the surface requirements.

One approach to circumvent the limitation of the workable component size is to use a selective method, as is known from DE 10 2014 108 447 A1. This discloses a system for selective plasma polishing and/or cleaning of the electrically conductive surface of components, in particular sheets and foils, which has at least one cathodically polarized polishing basin, which is supplied with the electrolyte via a pump system. The anodically polarized workpiece is then passed through this basin, wherein insulating strips running transversely to the workpiece limit the surface in contact with the electrolyte, thus creating a polishing bath that only acts selectively. While such a device eliminates the process limit of the maximum component size, geometrically complex components cannot be machined with it, or only to a very limited extent. In addition, it does not allow for selective machining of individual surfaces apart from a one-dimensionally defined overall portion.

For this reason, a special plasma-electrolytic machining process, the so-called jet plasma polishing, provides the use of an electrolyte jet instead of an electrolyte bath, wherein in this case, the electrolyte nozzle, which directs an electrolyte jet onto the workpiece, simultaneously forms the cathode. Material is only removed at the point where the electrolyte jet impinges on the surface of the workpiece. The maximum required current intensity is thus limited and the machining can be focused on selected areas.

A system for implementing the method described above is known from DE 20 2019 001 138 U1. This document describes a system for plasma polishing of an electrically conductive surface of a workpiece, wherein the system has a holding device for holding the workpiece as well as an electrolyte container, from which the electrolyte is conveyed to a nozzle unit. The nozzle unit is used to generate an electrolyte jet directed at the surface to be machined in order to machine the workpiece surface. This jet can be directed onto the workpiece as a free jet outside the electrolyte basin and used for plasma-electrolytic machining (jet plasma polishing) as well as be positioned in the electrolyte basin itself. In the latter case, the machining of the workpiece, as is known from the state of the art, takes place in the electrolyte bath (bath plasma polishing), wherein the directed flow of the electrolyte onto a surface of the workpiece influences the formation of the vapor skin and thus the process control in a targeted manner.

A disadvantage of the system described is that only comparatively small areas of a workpiece surface are machined, which means that the machining of larger surfaces takes a long time and also the machining of complex contours cannot be carried out satisfactorily.

Based on the devices and methods known from the state of the art for plasma-electrolytic machining of workpiece surfaces, the invention is based on the object of specifying a technical solution, using which comparatively large surfaces and/or different, complex contours can be plasma-electrolytically machined in a suitable manner. In particular, it should be possible to produce high-quality surfaces quickly, reliably and repeatably, even on workpieces with different geometries and/or complex surface contours. It should also be practically feasible to deburr comparatively large components, taking into account both technical and economic boundary conditions.

The technical solution to be specified should generally be suitable for use in industrial processes, in particular in series production, and it should be possible to integrate it into industrial production in an economically sensible manner using relatively simple means. Furthermore, the technical solution to be specified should be suitable for being adapted to different machining tasks, in particular to the machining of differently shaped workpieces, without considerable design effort. Furthermore, a machining system should be specified, that can be manufactured and operated effectively, taking into account the known design principles and economic aspects. In that, the energy demand required for plasma-electrolytic machining of workpieces with differently shaped workpiece surfaces should be minimized and, in addition, it should be possible to limit current intensity peaks as simply as possible.

### SUMMARY

A device (1) and a method for plasma-electrolytic machining of an electrically conductive surface (2) of a workpiece (3) are described. The device has an application unit (4) for applying an electrolyte jet to the surface (2), a supply unit (5) for at least temporarily supplying the application unit (4) with the electrolyte required to generate the electrolyte jet, at least one electrode (6), which forms a counter-electrode to the surface (2) during machining, and at least one electrical energy source (7), using which the electrode and the surface can be supplied with electrical energy during machining, such that a current flows between the electrode (6) and the surface (2) to be machined upon contact with the electrolyte.

The technical solution described is characterized in that the application unit (4) is designed to apply a first and at least one second electrolyte jet, which have different jet effect areas on the surface to be machined, simultaneously or consecutively to the surface (2) of the workpiece (3).

### DETAILED DESCRIPTION

The object described above is solved with a device according to claim 1 as well as a method according to claim 13. Advantageous embodiments of the invention are the subject of the dependent claims and are explained in more detail in the following description with partial reference to the figures.

The invention relates to a device for plasma-electrolytic machining of an electrically conductive, in particular a metallic surface of a workpiece, which has an application unit for applying an electrolyte jet to the surface, a supply unit for at least temporarily supplying the application unit with the electrolyte required for generating the electrolyte jets, at least one electrode, which forms a counter electrode to the surface, in particular a cathode, during machining, and at least one unit, using which the electrode and the surface can be supplied with electrical energy during machining in such a way, that a current flows between the electrode and the surface to be machined upon contact with the electrolyte. According to the invention, the device is characterized in that the application unit is designed to generate a first and at least one separate second electrolyte jet, which have different jet shapes, jet directions, jet effect areas, spatial arrangements, jet compositions and/or flow characteristics, and to apply the first and the at least one second electrolyte jet to the surface of the workpiece simultaneously or consecutively. The essential idea of the invention is thus based on providing an application unit, via which at least two jets with different characteristics, in particular from different directions and with different effective areas, can be applied to the workpiece surface to be machined simultaneously or consecutively. In this context, a jet effect area is to be understood as an area of the surface of a workpiece to be machined, onto which an electrolyte jet impinges, so that at least one surface characteristic in this area changes at least partially. Here it is essential that the surface of a workpiece is simultaneously or consecutively machined by means of at least two electrolyte jets, which differ in terms of at least one characteristic, their orientation, their spatial arrangement and/or the jet effect area, on which the at least two electrolyte jets have an impact. The at least two electrolyte jets initially generated by the application unit are separate jets, which preferably emerge from different outlet openings of the application unit and do not mix on the flow path between the application unit and the jet effect areas on the workpiece surface to be machined, in particular do not mix to form a homogeneous jet. In a particularly preferred manner, the at least two separate electrolyte jets impinge on two jet effect areas on the workpiece surface, which do not or only partially overlap. The separate electrolyte jets provided according to the invention are thus characterized by the fact that they are always independent jets, the characteristics of which can be adjusted as required, as opposed to splitting a stream into individual stream filaments, such as is effected by a perforated plate or a jet-breaker. Here, a jet can be briefly separated into different flow filaments by a perforated plate or a jet-breaker, but these reunite to form a common jet after flowing through the flow obstacle in the form of a perforated plate or a jet-breaker. In contrast to this, according to the invention, at least two electrolyte jets are generated and directed onto a workpiece surface, so that at least partially different jet effect areas can also be machined on the workpiece surface. Here it is essential that the characteristics of the at least two separate electrolyte jets can be set differently, thus enabling workpieces, even those with complex surface contours, to be machined as required.

In a particular manner, the at least two electrolyte jets are aligned or can be aligned in such a way that their projection area corresponds at least in certain areas to the shape and/or contour of the surface to be machined. In the context of the invention, machining means material removal of the surface material, cleaning, changing at least one characteristic of the surface layer and/or applying a material to the surface, in particular polishing, deburring, oxidizing, degreasing and/or de-oiling. With regard to the supply unit, it is advantageous, if it has at least one conveying element, for example in the form of a centrifugal, impeller or gear pump, which enables at least virtually pulsation-free conveying of the electrolyte to the application unit. This is advantageous, since pulsations of an electrolyte jet applied to the workpiece surface impair the stable formation of the vapor skin on the workpiece surface.

In this context, it is generally conceivable that the device is a stationary or a portable device for the suitable machining of electrically conductive, in particular metallic surfaces. It is thus conceivable that the system is designed as a stationary machine tool for machining workpiece surfaces or as a portable, preferably hand-guided machine tool, which is respectively moved to the workpiece to be machined. By means of the technical solution according to the invention, it is thus possible in a comparatively simple manner to plasma-electrolytically machine a given contour of an electrically conductive workpiece surface, preferably in an automated manner, in particular to polish and/or deburr it. Due to the flexible design of the device according to the invention, electrolyte jets with different characteristics can be applied to a surface to be machined in three-dimensional space simultaneously or at a time interval from one another. According to a preferred embodiment, the application unit is designed in such a way that at least two electrolyte jets can be applied to the workpiece surface to be machined from different directions simultaneously or at a time interval. In this case, the application unit preferably has at least two outlet openings, in particular nozzles, via which an electrolyte jet can be applied to the workpiece surface to be machined in a targeted manner. The outlet openings are preferably arranged in such a way that at least one of the electrolyte jets for surface machining can be applied to surfaces with different contours at a process-specific angle. This angle should preferably be selected such that the electrolyte jet is aligned along the surface or contour normal. However, due to accessibility, surface geometry or the machining target, among other things, it may also be advantageous to select a deviating angle. In this context, it is conceivable that the entire application unit and/or individual outlet openings can be moved in a targeted manner.

In a special further development of the invention, it is provided that the application unit has at least one control element, by means of which the jet shape, jet direction, jet effect area, jet composition and/or a flow characteristic of the electrolyte jet can be changed. Such a control element thus ensures that electrolyte jets with different characteristics and adapted to the respective requirement or the respective machining task can be applied to the surface of a workpiece. In this context, it is conceivable that such a control element is designed to change the size, shape and/or orientation of an outlet opening, in particular a nozzle, as required. It is therefore generally conceivable to vary the orientation of an electrolyte jet, the jet shape, the flow velocity and/or the volume flow by means of such an outlet opening. An at least temporary interruption or pulsed application of at least one of the electrolyte jets is also conceivable. Alternatively, or in addition, it is conceivable that the control element has at least one valve and/or a dosing unit, by means of which the composition of the electrolyte jet dispensed by the application unit can be changed. It is likewise conceivable that a control element has at least one actuator, a mixing element and/or a heating element in order to adapt the flow characteristics and/or the temperature of the electrolyte to the requirements of the respective machining task in a suitable and targeted manner. An electrolyte temperature of 60° C. to 95° C. is preferable for plasma polishing, as this reduces the energy to be introduced until the electrolyte evaporates. This can be realized, for example, by screw-in heaters, continuous-flow heaters, ceramic heaters or a combination hereof. On the other hand, e.g. plasma-electrolytic oxidation is also possible with electrolytes at room temperature.

In a further special embodiment of the invention, at least one measurement unit is provided for continuously or discontinuously measuring at least one characteristic of the surface, for determining a distance between the application unit and/or an outlet opening of the application unit and the surface and/or for determining the relative position of the application unit to the surface. Furthermore, at least one control unit is preferably provided, by means of which a control signal can be generated and transmitted to the application unit for changing the jet shape, the jet direction, the jet effect area, the jet composition, the spatial arrangement of the electrolyte jets, the activation or deactivation of at least one electrolyte jet and/or a flow characteristic of at least one of the electrolyte jets as a function of a characteristic of the workpiece surface, a measured value generated by the measurement unit and/or a setpoint value. Such a control unit, which advantageously is freely programmable, thus enables a particularly flexible use of a device designed according to the invention. The control unit is preferably designed such that the individual required process parameters, such as temperature, flow shape, flow velocity, volume flow and/or composition of at least one of the electrolyte jets, can be changed as required. Alternatively, or in addition, it can be provided that the control unit is designed to vary the voltage applied between the electrode and the workpiece surface as required, in particular to set the voltage to a value above or below a limit value. The limit value is advantageously selected in such a way that plasma-electrolytic machining of the workpiece surface takes place at a voltage above the limit value, while electrochemical machining of the workpiece surface takes place at a voltage below the limit value. Thus, for example, the roughness can first be reduced electrochemically at a high removal rate and then, by changing the voltage, a high-quality, shiny surface can be produced plasma-electrolytically. It is particularly advantageous to combine such a control unit with at least one of the control elements described above in order to be able to generate and apply at least two electrolyte jets with different characteristics to the workpiece surface to be machined in a particularly flexible and effective manner and/or to change the type of surface machining by changing the voltage.

In a further special embodiment of the invention, this has at least one measurement unit for continuous or discontinuous measurement of at least one characteristic of the workpiece surface, in particular of the surface roughness, and/or for continuous or discontinuous determination of the relative position of the application unit to the surface. In an advantageous embodiment, the measurement unit is directed at the jet effect area. Alternatively, or in addition to this, at least two measurement units can be provided, in particular for an intended relative movement of the application unit to the workpiece surface, which cover at least one area before and one after the jet effect area. The characteristics of the surface can be recorded optically, in particular, for example, by a gloss measurement via a camera or the laser-based recording of a roughness profile. In order to determine the relative position, ultrasonic measurement, among others, is also an option.

A combination of such a measurement unit with at least one of the previously described control units and one of the previously described control elements is particularly advantageous in order to be able to use the measurement results directly to control the machining process. Thus, for example, the relative speed of the application unit to the surface, the machining voltage or the jet composition of the electrolyte can be changed depending on a comparison of the measurement by the measurement unit to a target state. In addition, such an arrangement allows for the continuous recording of data for the purpose of effective quality assurance.

According to a further particularly suitable embodiment of the invention, the application unit has at least two outlet openings, in particular two nozzle elements, for applying electrolyte jets. Preferably, these outlet openings and/or the elements forming them are movably arranged, differently dimensioned, can be supplied with the electrolyte separately from the supply unit and/or are designed in such a way that at least two electrolyte jets with different jet shapes and/or flow characteristics can be applied to the workpiece surface. According to the invention, the application unit can be adapted flexibly and yet with comparatively simple means to the existing requirements, in particular the material to be machined and the surface contour, depending on the respective machining task. In that, it is furthermore generally conceivable that suitable fixing and/or movement devices are provided in order to produce a relative movement between the workpiece surface to be machined and the application unit, in particular at least one outlet opening for one electrolyte jet. A corresponding relative movement can be initiated, for example, by optionally moving the workpiece, the surface of which is to be machined, and/or at least partially moving the application unit.

In a further particular embodiment of the invention, it is provided that the application unit and/or at least parts of the supply unit, in particular those for collecting the electrolyte already applied to the workpiece, are arranged on at least one robot arm. In this way, a particularly flexible movement of the application unit relative to the workpiece surface to be machined can be enabled by using an industrial robot. Alternatively, the use of axle kinematics is also possible.

According to a special further development of the invention, at least one adjusting unit is provided for changing a distance between the surface of the workpiece to be machined and at least one outlet opening of the application unit and/or a relative arrangement of at least one outlet opening of the application unit and the workpiece surface to be machined. In an advantageous manner, suitable movements of the application unit and/or of the workpiece can be initiated by means of a robot arm and/or axle kinematics. With such an adjusting unit, the size of the gap to be overcome by at least one electrolyte jet between at least one of the outlet openings and the surface to be machined can thus be adjusted in a targeted manner. In this manner, not only the force with which an electrolyte jet impinges on the workpiece surface and thus influences the formation of the vapor skin, but also the polishing current occurring at a given electrical voltage as well as the electrical voltage required to generate the necessary polishing current can be adjusted in a targeted manner. A small distance is advantageous in terms of the geometric fidelity of the jet shape to the outlet opening, particularly in the case of electrolyte jets that do not run along gravity. In that, however, a minimum distance must be observed to prevent sparkover.

According to a further special embodiment of the invention, it is provided that the polishing current flowing during the machining of the workpiece surface is measured. The corresponding measured value can then be used in a suitable manner to control or even regulate the machining process. In a particular further development, in this respect, it is provided that, if the measured current intensity of the polishing current corresponds to a target value, it is assumed that the process is running at least almost faultlessly. If, on the other hand, the current intensity changes significantly from time to time, i.e. the corresponding value repeatedly fluctuates strongly, in particular upwards towards a higher value, it is preferably concluded that the vapor skin is breaking down and a new ignition is then occurring.

In this manner, quality assurance can be advantageously realized and/or the measured values obtained and/or the values derived therefrom can be used to change a characteristic of the control element and/or of the actuator and thus to influence the surface machining process in a targeted and needs-based manner.

In a further particularly special embodiment of the invention, it is provided that an electrode, preferably a cathode, surrounds the electrolyte jet at least in certain areas. Advantageously, the electrode is here designed as an electrically conductive piece of pipe, which surrounds the electrolyte jet in the area of the outlet opening and thus forms the electrode in a suitable manner. In this context, it is conceivable that the application unit is designed to be electrically insulating and has at least individual electrically conductive areas, which, in operation as electrodes, in particular cathodes, form the counter-electrodes to the workpiece surface to be machined. The electrically conductive areas of the application unit are preferably designed as pieces of pipe, wherein the respective outlet opening for the exit of an electrolyte jet is provided at the end of the pieces of pipe.

During a machining process, it is conceivable that the electric field and thus the areas of the workpiece surface to be machined are varied by selectively switching the electrically conductive areas provided at the application unit on and off. It is likewise conceivable that the entire application unit is designed electrically conductive and forms the electrode of the device according to the invention during a machining process. In that, number and design of the electrodes always take into account that for the safe and stable operation of a plasma polishing system, the cathode area should be larger than the anode area, wherein a ratio of at least 5:1 is preferable.

According to an alternative or supplementary embodiment, the flow of an electrolyte from at least one outlet opening of the application unit can be switched on and off as required, i.e. it can be pulsed.

In a further special embodiment, it is provided that a supply of electrical energy to the electrode as well as to the surface to be machined can be changed by means of at least one actuator. In this context, it is conceivable that the actuator is designed in such a way that the supply of electrical energy is completely interrupted, at least temporarily, or that only the current intensity or voltage is changed. Preferably, a DC voltage of 200 V to 450 V is applied between the electrode and the surface to be machined. This is particularly suitable for polishing and/or deburring a workpiece surface. If the voltage is lowered, for example to a value of 120 V, the workpiece surface is no longer machined plasma-electrolytically, but rather electrochemically. Since electrochemical machining results in greater material removal per unit of time on the workpiece surface, the type of machining, in particular the size or speed, resp., of the material removal, can be changed in a targeted manner by changing the voltage.

According to a particular embodiment of the invention, the supply unit has an electrolyte supply, via which electrolyte is supplied to the application unit, an electrolyte discharge, via which electrolyte applied by the application unit is at least partially discharged, and a treatment unit, via which at least one characteristic of the discharged electrolyte, in particular the temperature, the pH value, the conductivity and/or the turbidity, can be changed. The supply unit according to this embodiment is advantageously designed in such a way that the electrolyte is first applied by the application unit to the workpiece surface to be machined, then collected and advantageously treated, so that the electrolyte can be used again for machining the workpiece surface. Preferably, the electrolyte discharge has a blower unit, a compressed air unit and/or a suction unit, so that the electrolyte is sucked off and/or blown away after impinging on the surface to be machined. Preferably, the electrolyte that has impinged on the surface is sucked off or blown away in a targeted manner and discharged via a drain, so that it may be reused after treatment. This prevents erosion phenomena from occurring in surrounding areas outside the targeted surface.

In this context, it is advantageous, if at least one sensor unit is provided, using which at least one characteristic of the electrolyte, above all its conductivity, pH value, turbidity and/or temperature, can be detected. In this manner, it is conceivable, for example, that the salt content of the electrolyte used can be measured via a conductivity measurement and raised to the required level again as needed using a suitable dosing unit. Further measures can likewise be initiated, such as the appropriate metered addition of at least one pH regulator and/or the purification of the electrolyte, for example by means of suitable filter elements, such as a cyclone separator, filters, or the metered addition of chemically active substances.

By means of electrolyte treatment, the electrolyte can be used over a comparatively long period of time, and thus a particularly economical operation of the device according to the invention can be realized. In this context, it is advantageous, if the device according to the invention has containers for storing substances that are required for metered addition and/or purification.

Alternatively, or in addition, a cleaning unit is provided, which enables cleaning of the application unit and/or the outlet openings, wherein cleaning is preferably carried out as soon as the electrolyte is exchanged.

In a further embodiment of the invention, the device has at least one emitter, using which sound waves and/or electromagnetic waves can be coupled at least temporarily into at least one of the electrolyte jets. By means of such an emitter, it is possible to couple sound waves and/or electromagnetic waves into at least one electrolyte jet, in particular in order to change the machining of the workpiece surface or to effect an additional application of force into the surface, resp. A corresponding impact on the surface can thus be achieved by means of sound waves, in particular to influence the formation of the vapor skin, or with suitable electromagnetic radiation, for example high-energy laser radiation. It is likewise conceivable to couple a light beam with a specific color into at least one of the electrolyte jets, for example by means of an LED, in order to provide an indication of the presence of the machining voltage and the existence of a corresponding risk for the operator in the event of contact. A corresponding light beam coupled into at least one electrolyte jet can thus provide a warning for a user and advantageously forms part of a special safety device.

According to a particular embodiment of the invention, it is provided that a device according to the invention is combined with further components, in particular in order to be able to realize an effective integration into an industrial manufacturing process, combined with maintenance-free operation over as long a period as possible. In a particular embodiment, an electrolyte concentrate container is provided for storing at least one concentrate, wherein the ready-for-use electrolyte is advantageously produced by mixing the concentrate with water, preferably with deionized water. Such production can preferably be carried out automatically. It is likewise conceivable to supplement a corresponding manufacturing process with the treatment process described above. In that, a device for preferably continuous treatment can in turn have special components, such as a filter system for suspended particles, in particular with a cyclone filter, a dosing unit for the metered addition of precipitants and/or an electrolysis cell.

Alternatively, or additionally, a container for storing pH regulators can be provided in order to acidify the electrolyte by means of a dosing unit during the process. Furthermore, it is also conceivable to provide a storage container for at least one cleaning agent, so that the application unit, above all the at least one outlet opening, can be cleaned, preferably automatically. Preferably, cleaning takes place when the electrolyte is exchanged.

In a special embodiment of the invention, elements are provided for moving the workpiece before, after or during the machining of the workpiece surface, which simultaneously enable the transfer of electrical energy to the workpiece surface to be machined. Such means for movement can, for example, be designed as rollers that are pressed against the workpiece with a suitable pressure. It is furthermore conceivable to use sliding contacts to transfer electrical energy to a workpiece that is moved relative to the application unit.

According to a special further development of the invention, at least one unit is provided, via which air and/or at least one gas can be introduced at least temporarily into at least one of the electrolyte jets. This is advantageous, since air or gas bubbles in an electrolyte jet generally promote the formation of the vapor skin on the workpiece surface to be machined. Preferably, the unit for introducing air and/or gas into an electrolyte jet has at least one suitable jet regulator. In this context, it is conceivable that at least one outlet opening of the application unit has an exchangeable insert, which at least favors the injection or suction of air and/or gas into an electrolyte jet in the area of the outlet opening.

Alternatively, at least one of the outlet openings has a suitable internal structure, in particular a surface structure, which enables a suitable supply of air and/or gas into the electrolyte jet and/or the formation of air and/or gas bubbles in the electrolyte jet.

It is furthermore conceivable that an electrically insulating spacer is provided in the area of at least one of the outlet openings of an application unit, which at least partially encloses the electrolyte jet and thus relocates the effective outlet opening of the free jet closer towards the workpiece surface. The remaining distance can be reduced to zero, so that the spacer creates a direct, electrically insulating connection to the workpiece surface. Preferably, such a spacer is tubular in shape, at least in sections, so that the electrolyte jet impinges on the workpiece surface to be machined through such a spacer. An electrolyte jet is thus applied in a targeted manner, which means that the distance to be covered by the free jet can be reduced to zero.

In a further embodiment of the invention, at least one outlet opening of the application unit has a suitable surface structure on its inner side in order to produce a desired flow shape of the electrolyte jet. Furthermore, it is conceivable in this context that the effective cathode surface is increased due to a structured surface in the area of the outlet opening. In that, both deterministic structures, such as nets, grids and/or tubular textures, and stochastic structures, for example in the form of sintered and/or sponge-like structures, are conceivable as surface structures. These surface structures, which are preferably selected depending on the respective machining task, can also be inserted into an outlet opening of an application unit in the form of interchangeable inserts.

Furthermore, it is advantageous, if storage units, such as accumulators or capacitors, in particular supercapacitors, are used to supply the device according to the invention with electrical energy. In this manner, it is possible to minimize peak loads of current intensity, which can occur in particular during the ignition process at the start of a machining operation. Respective peak loads can be reduced at least in part using such electrical energy storage units. In this manner, the power consumption of a device according to the invention is decoupled from the power output of the available electrical network. By using at least one of the electrical storage units described above, impermissible loads on the power grid of an industrial operation can be excluded, thus guaranteeing safe, continuous operation of a device according to the invention. In addition, it is conceivable to design the storage elements in such a way that the current intensity provided by them can be maintained over a longer period of time, in particular the machining time of a workpiece. In this manner, for example, a system limited to a 150 A machining current due to the connected load could be used to machine workpieces that require the provision of a 200 A machining current by charging it accordingly.

In addition to a device, the invention also relates to a method for plasma-electrolytic machining of an electrically conductive, in particular metallic surface of a workpiece, in which at least one electrolyte is conveyed to an application unit, via which an electrolyte jet is at least temporarily applied to a surface of a workpiece, and in which an electrical voltage is applied between the surface of the workpiece to be machined and an electrode, which are at least partially in contact with the electrolyte, so that during machining the electrode forms a counter-electrode, in particular a cathode, to the surface of the workpiece, which preferably represents the anode. The method according to the invention is characterized in that a first and at least one second electrolyte jet, which have different jet shapes, jet directions, jet effect areas, jet compositions and/or flow characteristics, are simultaneously or consecutively applied to the surface of the workpiece via the application unit. The method according to the invention is thus essentially characterized by the fact that the surface of a workpiece to be machined is simultaneously or consecutively machined with electrolyte jets of different characteristics. During machining, material is removed, the surface is cleaned, at least one surface characteristic is changed and/or material is applied.

The electrolyte jets are preferably dispensed from a movable, preferably from a plurality of movable outlet openings in the direction of the workpiece surface to be machined.

The at least two electrolyte jets initially generated by or in the application unit are separate jets, which are preferably dispensed from different outlet openings of the application unit and do not mix on the flow path between the application unit and the jet effect areas on the workpiece surface to be machined, in particular do not mix to form a homogeneous jet. In a particularly preferred manner, the at least two separate electrolyte jets impinge on two jet effect areas on the workpiece surface, which do not or only partially overlap. The separate electrolyte jets provided according to the invention are thus characterized by the fact that they are always independent jets, the characteristics of which can be adjusted as required, as opposed to splitting a stream into individual stream filaments, such as is achieved by a perforated plate or a jet-breaker. Here, a jet can be briefly separated into different flow filaments by a perforated plate or a jet-breaker, but these reunite to form a common jet after flowing through the flow obstacle in the form of a perforated plate or a jet-breaker. In contrast to this, according to the invention, at least two electrolyte jets are generated and directed onto a workpiece surface, so that at least partially different jet effect areas can also be machined on the workpiece surface. Here it is essential that the characteristics of the at least two separate electrolyte jets can be set differently, thus enabling workpieces, even those with complex surface contours, to be machined as required.

According to a particular embodiment of the invention, the surface to be machined is subjected to electrolyte jets that are directed onto the surface from different directions. The electrolyte jets can each be interrupted as required and/or the characteristics of the electrolyte jets can be varied.

Furthermore, it is advantageous for the surface of the workpiece to be machined to be moved relative to the application unit. In that, a relative movement can optionally be generated by moving the application unit or at least one outlet opening of the application unit and/or the workpiece. With the method according to the invention, it can thus be achieved, in particular when using an application unit with a plurality of outlet openings, in particular nozzles, that a workpiece, even with a comparatively complicated geometry and surface contour, is machined, for example deburred, in such a way that a surface with a comparatively high surface quality is produced.

In a special embodiment of the invention, the electrolyte is at least partially collected following application to the surface of the workpiece, the collected electrolyte is being treated by changing at least one characteristic and, in the treated condition, reapplied to the surface of the workpiece. According to this embodiment, the electrolyte is recirculated, wherein intermediate storage in a tank is conceivable. In this manner, particularly effective machining of a workpiece surface is possible due to using an electrolyte over a comparatively long period of time. Furthermore, it is conceivable to store substances required for treatment and/or purification of the electrolyte in suitable containers and to add them, as required, preferably using a suitable regulation or control, in particular in order to increase the salt content and/or to reduce the pH value.

According to a particularly special further development of the invention, the design of the application unit, in particular its shape, the arrangement of the at least one outlet opening and/or the control elements for changing at least one characteristic of an electrolyte jet, is such that the outer contour of the application unit and/or the projection areas of the electrolyte jets applied at least almost completely reproduce the shape of the surface of a workpiece to be machined. Advantageously, here it is conceivable that the application unit is arranged in a stationary manner, for example on a machine frame, and the workpiece to be machined is inserted automatically or semi-automatically. Once the workpiece, the surface of which is to be machined, has been positioned, in this case, preferably the supply unit, the application unit and a voltage source are activated, so that a plurality of electrolyte jets are applied to the surface to be machined simultaneously or consecutively and a voltage is applied between the electrode and the workpiece surface. Due to the formation of a partially ionized gas envelope, a plasma stabilizes on the surface of the workpiece and the desired machining occurs, in particular a removal of material.

It is likewise conceivable that the application unit and/or individual application openings are at least temporarily moved relative to the workpiece. Thus, it is conceivable that these, once the workpiece has been inserted, are initially moved into a machining position and, following completion of the machining process, are returned into their initial position. Furthermore, continuous machining of a workpiece is conceivable, in which both the workpiece and at least parts of the application unit, such as individual outlet openings, are moved.

In general, continuous machining of a workpiece, for example by moving the workpiece, as well as machining in several discrete steps are conceivable.

Preferably, such a division into discrete machining steps can be undertaken such that these have a need for electrical power as equal as possible and the network is burdened by the method as uniformly as possible.

Furthermore, it is conceivable that the electrolyte supply and/or the energy supply for generating an electrical voltage is at least temporarily interrupted between individual machining steps, in particular in order to be able to realize an optimal process in regard to economic production.

The device according to the invention as well as the method according to the invention can be advantageously used for deburring metallic workpieces. Alternatively, or in addition, it is conceivable that workpiece surfaces are polished, sterilized and/or cleaned by means of the solution according to the invention. Furthermore, it is conceivable that plasma-electrolytic oxidation (PEO) occurs on the workpiece surface to be machined by using suitable electrolytes and the determination of suitable process parameters, in particular for the voltage applied between electrode and workpiece surface. By means of such a method, particularly hard, wear-resistant boundary layers, such as on aluminum and magnesium, can be generated and/or plasma-electrolytic coating of workpiece surfaces can be realized.

Preferably, for plasma-electrolytic oxidizing, a voltage of approx. 200 V is applied between the electrode and the workpiece surface to be machined. In this context, it is conceivable that workpiece machining is undertaken by using a first electrolyte and a first voltage profile in a first step in order to effect a targeted removal of material from the surface to be machined, while subsequently plasma-electrolytic coating or plasma-electrolytic oxidation (PEO) is undertaken in a second process step by means of a second electrolyte and a second voltage profile. Using a suitably designed control unit and/or a control element, which can be activated by the control unit in a targeted manner, it is conceivable that a two- or multi-stage process designed as mentioned above is performed by means of an application unit or by using at least two application units, wherein material is removed by one of them and material is applied or changed by another.

Furthermore, it is conceivable to perform the method according to the invention in such a way that an electrically conductive, in particular metallic surface is not only deburred and/or polished, but a further removal of material is also realized.

For such a case, the machining of a workpiece surface is performed over a longer period of time, e.g. in order to produce a rounding in the area of a workpiece contour or to smooth the surface profile, as it is regularly required for additively manufactured metal components. For that, preferably either the dwell time of an outlet opening above the area of the workpiece surface to be machined is extended and/or the voltage is briefly reduced. This reduces the effects on the workpiece surface caused by plasma-electrolytic machining and shifts the operating principle towards electrochemical machining of the surface, which in turn is accompanied by a significantly higher velocity of material removal.

Furthermore, it is conceivable to increase the flow velocity of the electrolyte and/or to change the flow shape, i.e. in particular to change a laminar flow into a turbulent flow. In this case, a change is undertaken such that the thickness of the gas or vapor layer present on the workpiece surface is reduced or its formation as well as its flow are influenced. According to a particular further development of the invention, air and/or a gas are blown into the electrolyte jet in order to generate a turbulent flow of the electrolyte jet along the workpiece surface and thus favor the formation of the gas-plasma envelope. In this context, a controlled or regulated injection as well as suction of air and/or gas into at least one of the electrolyte jets is conceivable.

Furthermore, it is conceivable, especially at the beginning of a machining process, to direct at least one electrolyte jet with a comparatively low flow velocity to the workpiece surface and to raise the flow velocity to the usual level in a next process step. In that, a respective change of the flow velocity of at least one electrolyte jet can be undertaken independent of the number, shape and size of the outlet openings of an application unit. Furthermore, it is advantageous to apply an ignition voltage between the electrode and the workpiece surface to be machined deviating from the operating voltage at the beginning of a work process, i.e. during the so-called ignition and the generation of a plasma on the workpiece surface to be machined, and/or to promote the ignition process by an increased or reduced addition of air and/or gas into the electrolyte jet.

According to a special further development of the invention, at least one of the electrolyte jets is not directed to the surface of the workpiece as a free electrolyte jet, but a spacer, which is not electrically conductive, is arranged between the outlet opening of an application unit and the workpiece surface. Such a spacer preferably is made of ceramics, plastics and/or glass.

In a special embodiment, machining of a workpiece surface is undertaken by means of the method according to the invention with a stationary application unit, which preferably is part of a quick clamp device, wherein, following proper fixation of the workpiece to be machined, the required machining position of the surface to be machined relative to the application unit is already set and the required electrical contacts are established.

It is likewise conceivable to initiate a continuous or clocked relative movement between the workpiece to be machined and the application unit by moving the application unit and/or the workpiece in a suitable manner. In this context, it is conceivable that a feed movement of the workpiece is at least temporarily achieved by means of a roller system, wherein the rollers advantageously are simultaneously electrically conductive and enable the transfer of electrical energy to the workpiece surface to be machined. Alternatively, it is conceivable to provide suitable sliding contacts for the transfer of electrical energy to the workpiece surface to be machined.

Furthermore, a special embodiment of the invention provides that, following machining of a workpiece surface and/or between individual machining steps with material removal, material change or material application, at least one cleaning, drying and/or inspection step, in particular with a camera, is performed, preferably automatically. Cleaning preferably takes place with deionized water and/or ethanol.

In a further special embodiment of the method according to the invention, the workpiece is preheated prior to machining, in order to reduce the temperature difference to the electrolyte and to ensure process conditions as constant as possible over the entire machining period. Preferably, this takes place in a temperature-controlled fluid, which may also be the electrolyte itself.

Furthermore, for example, pre-heating of the workpiece via induction as well as, in particular for selective machining of individual surfaces, via infrared radiators is also conceivable.

A further special embodiment of the invention provides that the electrolyte is at least partially collected following application to the surface of the workpiece, treated by changing at least one characteristic of the electrolyte collected and reapplied to the surface of the workpiece in the treated or untreated condition.

Furthermore, it is advantageously provided that, before, during or after machining of the surface, at least one machining and/or process parameter, an electrical voltage prevailing between the electrode and the surface to be machined, an intensity of a current flowing between the electrode and the surface to be machined, a distance between the application unit and/or an outlet opening of the application unit and the workpiece surface, the supply with electrolytes, a movement of the workpiece, a movement of the application unit and/or at least one setting of an emitter, using which sound waves and/or electromagnetic waves are at least temporarily coupled into at least one of the electrolyte jets, is or are measured and/or adjusted.

Integration of the method according to the invention into an industrial manufacturing process is furthermore advantageously possible, if the contour of the workpiece surface to be machined is directly transferred from a CAD system into a control unit for controlling the application unit and/or suitable control elements provided for this purpose. By directly transferring the manufacturing data, and thus the geometric contour of the workpiece to be machined, complex workpiece contours can also be machined by means of the method according to the invention in a comparatively simple manner, which in particular enables effective deburring and/or polishing of workpieces in series production and/or additively manufactured components.

In order to avoid load peaks of the current intensity in the generation of the voltage between the at least one electrode and the workpiece surface to be machined required for plasma-electrolytic machining, it is conceivable to use suitable storage elements for storing electrical energy, such as accumulators and/or capacitors, in particular so-called supercapacitors. By using such energy storages, it is possible to buffer load peaks of the current intensity upon provision of the required voltage, in particular during the ignition process. This way, the power grid of an industrial operation can be relieved and particularly safe operation can be guaranteed. Finally, it is conceivable to design the storage elements in such a way that the current intensity provided by them can be maintained over a longer period of time, in particular the machining time of a workpiece. In this manner, e.g., a system limited to a 150 A machining current due to the connected load could be used to machine workpieces that require the provision of a 200 A machining current by charging it accordingly.

### BRIEF DESCRIPTION OF THE DRAWINGS

Without limiting the general idea of the invention, the invention is explained in more detail below by means of specific embodiments with reference to figures. Identical components are given the same reference signs in the different figures. In that:

FIG. 1: shows a first embodiment of a device designed according to the invention with an application unit arranged in a stationary manner, and

FIG. 2: shows a second embodiment of a device designed according to the invention with an at least partially movable application unit.

### DETAILED DESCRIPTION OF THE PREFERRED EMBODIMENTS

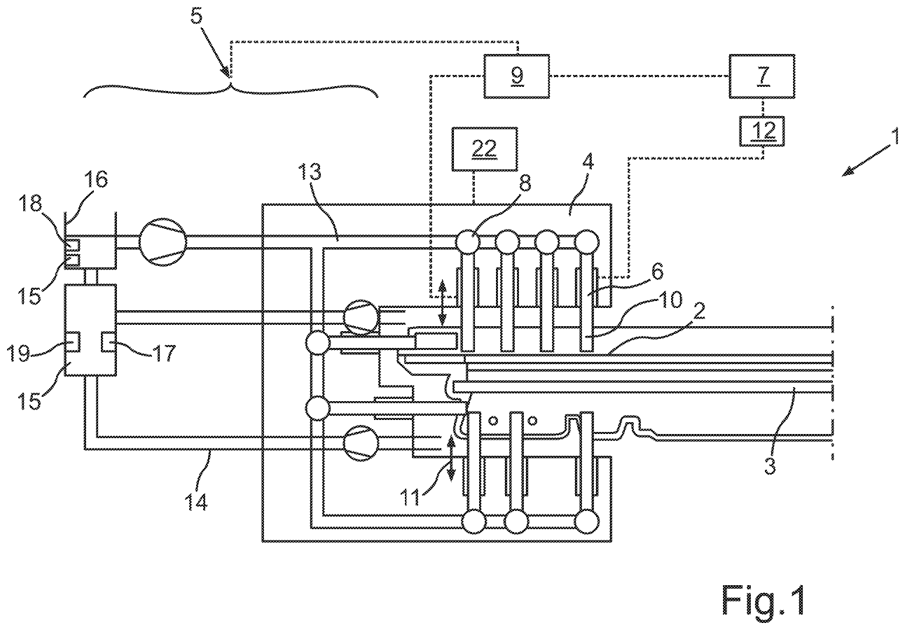

FIG. 1 shows a first embodiment of a device 1 designed according to the invention for plasma-electrolytic machining, preferably for deburring and/or polishing, of a surface 2 of a workpiece 3 in a schematic top view. The illustrated device 1 has a supply unit 5, which supplies an application unit 4 with the electrolyte required for plasma-electrolytic machining of a workpiece surface 2.

In that, the supply unit 5 has a pump, which conveys the electrolyte almost pulsation-free from a storage container 16 to several outlet openings 10 of the application unit 4 in the form of nozzles during operation. Conveying of the electrolyte starts once the workpiece 3, the surface 2 of which is to be machined, has been fixed in the machining position, wherein a plurality of electrolyte jets from the individual outlet openings 10 impinge on the workpiece surface 2 to be machined from various directions. The number of outlet openings 10, through which the electrolyte is dispensed, as well as their design and orientation are chosen depending on the contour of the workpiece surface 2 to be machined as well as the machining task. According to the embodiment shown in FIG. 1, a workpiece 3 previously manufactured in mechanical series production is to be deburred with the device 1 according to the invention.

The device 1 shown also has a control unit 9, using which the supply unit 5, but also an electrical energy source 7 used as a voltage source, as well as the individual control elements 8 of the device 1, using which the application of electrolyte jets and the characteristics of the electrolyte jets can be set and changed as required, are controlled. In order to be able to achieve suitable control of the different elements, a measurement unit 22 with suitable sensors for continuously or discontinuously measuring at least one characteristic of the surface 2, in particular its surface roughness, for determining a distance between the application unit 4 and the surface 2 and/or for determining the position and/or orientation of the application unit 4 relative to the surface 2 is also provided. The measurement unit 22 and the control unit are in uni- or bidirectional data exchange via a data transmission path, which can be designed wireless and/or wired.

In this manner, the electrical voltage applied between the electrodes 6 of the device 1 and the workpiece surface 2 during machining can be varied and the individual outlet openings 10 can be closed and opened in a targeted manner. Furthermore, the flow velocity and the volume flow of the individual electrolyte jets can be changed as required.

The electrolyte stored in a storage container 16 is pre-heated by means of a heating element 18 and then conveyed to the individual outlet openings 10 via the electrolyte supply 13 by means of a plurality of pumps, so that the individual outlet openings 10 can be separately supplied with the electrolyte. The supply of the electrolyte to the outlet openings 10 is further undertaken via control elements 8, such as valves, using which the flow characteristics can be varied in a targeted manner. Thus, via the outlet openings 10, at least two electrolyte jets with different characteristics are simultaneously or consecutively applied to the workpiece surface 2 to be machined.

During the machining process, a DC voltage from 200 V to 450 V is applied between at least one electrode 6, which according to the embodiment shown in FIG. 1 is respectively formed by a piece of pipe, the end of which forms the respective outlet opening 10, and the workpiece surface 2. As soon as the electrolyte jet impinges on the workpiece surface 2 to be machined, gas or vapor formation, resp., occurs and a gas-plasma envelope forms on the surface 2, under which the desired material removal occurs. Once the electrolyte has impinged on the workpiece surface 2, it is sucked off by means of an electrolyte discharge 14 of the supply unit 5 and fed to a treatment unit 15 for electrolyte treatment. Here, in a first step, suspended particles are removed by means of a cyclone filter. Thereafter, the turbidity, the pH value as well as the electrical conductivity of the discharged electrolyte are measured by means of at least one sensor unit 17. If the electrolyte is particularly heavily contaminated, a precipitant is added from a tank via a dosing unit to thus cause a precipitation reaction in the electrolyte, and the electrolyte is pumped into a separate treatment tank.

Furthermore, depending on the measured values for the conductivity and the pH value of the electrolyte, salt, for example ammonium salt, and/or a pH regulator is added as required from respective storage containers with suitable dosing units 19. The treated electrolyte is then returned to the storage container 16. A temperature sensor 20 and a heating element 18 are provided in the area of the storage container 16, so that the electrolyte is always heated to the required temperature before it is fed to the application unit 4 with the plurality of outlet openings 10.

According to the embodiment shown in FIG. 1, the machining of the workpiece surface 2 is undertaken by the workpiece 3 being fixed or clamped in place, resp., in the area of the application unit 4 of the device 1 designed according to the invention. Thus, for its machining, the workpiece 3 is moved into the position provided for this and fixed there. Subsequently, the individual nozzle-shaped outlet openings 10 are extended into their machining position. According to the embodiment described here, during machining of the workpiece surface 2, there is no relative movement between the application unit 4 as well as the workpiece 3, the surface 2 of which is to be machined.

The individual outlet openings 10 of the application unit 4, and thus the projection areas of the electrolyte jets they dispense, completely reproduce the shape of the surface 2 of the workpiece 3 to be machined. Following completion of machining, the outlet openings 10 are retracted into their rest position, so that the distance between the workpiece 3 and the outlet openings 10 is increased.

Thereupon, the fixation of the workpiece 3 is released and the deburred workpiece ejected.

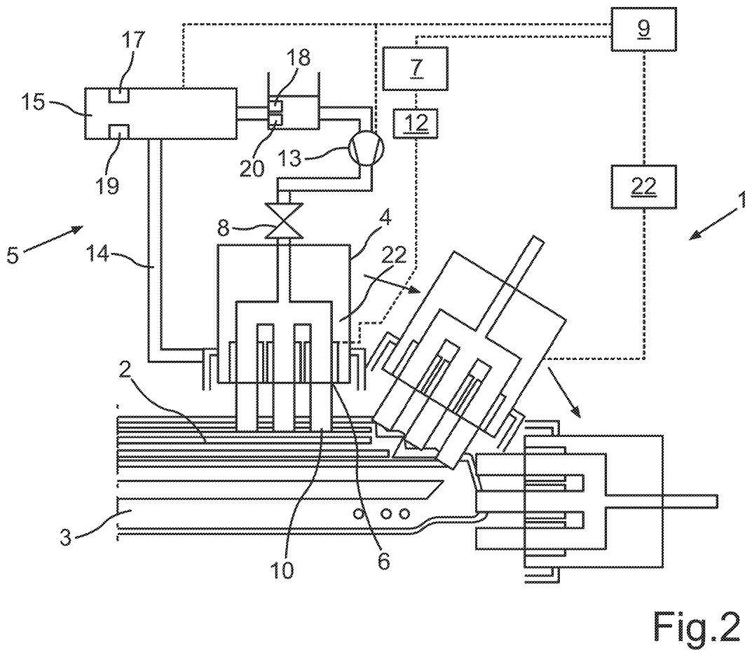

FIG. 2 shows a second embodiment of the device 1 according to the invention, wherein in this case, the application unit 4 has a movable nozzle head 21 with three outlet openings 10 in the form of nozzles. Via the outlet openings 10, different electrolyte jets can again be applied to the workpiece surface 2 to be machined as required. The supply of the individual outlet openings 10 with the electrolyte, the control of the application unit 4 as well as the treatment of the electrolyte sucked off from the workpiece surface 2 are undertaken with the same elements as explained in conjunction with FIG. 1.

Contrary to the embodiment shown in FIG. 1, the application unit 4 illustrated in FIG. 2, however, has outlet openings 10, which can be moved relative to the workpiece 3 also during machining, wherein, according to the embodiment shown, three nozzle-shaped outlet openings 10 are jointly moved with a nozzle head 21, as indicated with arrows, relative to the workpiece 3.

The controlled movement of the outlet openings 10 and the application of the electrolyte are undertaken depending on the contour of the workpiece 3 fixed or clamped, resp., in its machining position, wherein the movement of the nozzle head 21, the supply of electrolyte to the individual outlet openings 10, the switching on and off of the electrodes 6 arranged in the area of the outlet openings 10 as well as the setting of the voltage applied between an activated electrode 6 and the workpiece surface 2 to be machined are changed during machining as required, in particular depending on the contour of a surface area to be machined right then. The outlet openings 10 are again formed by pieces of pipe and their open ends, wherein the individual electrically conductive pieces of pipe take over the function of electrodes 6, here as cathodes, which during the machining represent the counter-electrodes to the anodic workpiece surface 2.

During a machining process, a voltage from 200 V to 450 V is applied between the respectively active pieces of pipe and the workpiece surface 2 to be machined. During the ignition process at the beginning of the workpiece machining as well as for initiating electrochemical machining steps, this voltage can be changed by changing a distance between the electrodes 6 arranged in the area of the outlet openings 10 and the workpiece surface 2 and/or targeted adjustment of the electrical energy source 7 serving as the voltage source.

During the machining process, the nozzle head 21 with its nozzle-shaped outlet openings 10 is then moved in such a way that the desired contour of the workpiece surface 2 is machined, here deburred.

With the device 1 shown in FIG. 2, in principle, two different forms of continuous machining of a workpiece 3 are possible. Thus, the application unit 4 with its nozzle head 21 can be set and positioned such that the outer contour of the workpiece 3 to be machined can hereby be exactly or approximately reproduced.

As soon as a respective positioning has been completed, the workpiece 3 is guided along the application unit 4 with the nozzle head 21 and its outlet openings 10. If individual surface areas of the workpiece 3 guided along the application unit 4 are not to be machined, it is possible to interrupt the application of electrolyte jets and/or the application of a voltage in this area, in particular via an actuator 12.

For the second conceivable form of continuous machining, the application unit 4 with the nozzle head 21 shown in FIG. 2 reproduces a generic shape, for example a rectangular shape or a hemisphere, with radially oriented outlet openings. In this case, it is conceivable, that the application unit 4 with its movably arranged nozzle head 21 is moved and positioned by suitable drive elements, such as industrial robot arms, in order to consecutively move along the surface areas of the workpiece to be machined.

### LIST OF REFERENCE NUMERALS

1 Device for plasma-electrolytic machining of an electrically conductive workpiece surface
2 Surface
3 Workpiece
4 Application unit
5 Supply unit
6 Electrode
7 Electrical energy source
8 Control element
9 Control unit
10 Outlet opening
11 Adjusting unit
12 Actuator
13 Electrolyte supply
14 Electrolyte discharge
15 Treatment unit
16 Storage container
17 Sensor unit
18 Heating element
19 Dosing unit
20 Temperature sensor
21 Nozzle head
22 Measurement unit

1. A device (1) for plasma-electrolytic machining of an electrically conductive surface (2) of a workpiece (3) having an application unit (4) for applying an electrolyte jet to the surface (2), a supply unit (5) for at least temporarily supplying the application unit (4) with the electrolyte required to generate the electrolyte jet, at least one electrode (6), which forms a counter-electrode to the surface (2) during machining, and at least one electrical energy source (7), using which the electrode and the surface can be supplied with electrical energy during machining, such that a current flows between the electrode (6) and the surface (2) to be machined upon contact with the electrolyte,
characterized in that the application unit (4) is designed to generate a first and at least one separate second electrolyte jet, which have different jet effect areas on the surface to be machined and are applied to the surface (2) of the workpiece (3) simultaneously or consecutively.

2. The device according to claim 1,
characterized in that the application unit (4) has at least one control element (8), by means of which the jet shape, the jet direction, the jet composition, the jet effect area and/or a flow characteristic of the electrolyte jet can be changed.

3. The device according to claim 1,
characterized in that at least one measurement unit (22) for continuously or discontinuously measuring at least one characteristic of the surface (2), for determining a distance between the application unit (4) and the surface (2) and/or for determining the relative position of the application unit (4) to the surface (2), and/or a control unit (9), by means of which a control signal can be generated as a function of a characteristic of the workpiece surface (2) and/or an associated setpoint value and can be transmitted to the application unit (4) in order to change the jet shape, the jet direction, the jet composition, the jet effect area, the spatial arrangement of the electrolyte jets and/or the flow characteristic of the electrolyte jet, are provided.

4. The device according to claim 1,
characterized in that the application unit (4) has at least two outlet openings (10).

5. The device according to claim 4,
characterized in that the outlet openings (10) are movably arranged, are of different dimensions, are tubular or nozzle-shaped, can be supplied with the electrolyte separately from the supply unit and/or are designed to apply at least two electrolyte jets with different jet shapes, jet effect areas, spatial arrangements and/or flow characteristics onto the workpiece surface.

6. The device according to claim 1,
characterized in that at least one adjusting unit (11) for changing a distance and/or the relative position between the surface (2) of the workpiece (3) and at least one outlet opening (10) of the application unit (4) is provided.

7. The device according to claim 1,
characterized in that the electrode (6) surrounds the electrolyte jet at least in certain areas during operation.

8. The device according to claim 1,
characterized in that a supply of the electrode with electrical energy, an electrical voltage prevailing between the electrode and the surface to be machined and/or an intensity of a current flowing between the electrode and the surface to be machined can be changed by means of at least one actuator (12).

9. The device according to claim 1,
characterized in that the supply unit (5) has an electrolyte supply (13), via which electrolyte can be fed to the application unit (4), an electrolyte discharge (14), via which electrolyte dispensed by the application unit (4) can be discharged, and/or a treatment unit (15), via which at least one characteristic of the discharged electrolyte can be changed.

10. The device according to claim 1,
characterized in that at least one sensor unit (17) is provided, using which at least one characteristic of the electrolyte can be detected.

11. The device according to claim 1,
characterized in that at least one emitter is provided, using which, at least at times, sound waves and/or electromagnetic waves can be coupled into at least one of the electrolyte jets.

12. A method for plasma-electrolytic machining of an electrically conductive surface (2) of a workpiece (3), in which at least one electrolyte is conveyed to an application unit (4), by which, at least at times, an electrolyte jet is applied to the surface (2) of the workpiece (3), and an electrical voltage is applied between the surface (2) of the workpiece (3) to be machined and an electrode (6), which are at least partially in contact with the electrolyte, so that the electrode (6) forms a counter-electrode to the surface (2) of the workpiece (3) during machining, characterized in that the application unit (4) generates a first and at least one separate second electrolyte jet, which have different jet effect areas and simultaneously or consecutively act on the surface (2) of the workpiece (3) via the application unit (4).

13. The method according to claim 12,
characterized in that the surface (2) of the workpiece (3) to be machined is being moved relative to the application unit (4).

14. The method according to claim 12,
characterized in that the electrolyte is at least partially collected following application onto the surface (2) of the workpiece (3), treated by changing at least one characteristic of the collected electrolyte and reapplied to the surface (2) of the workpiece (3) in its treated or untreated condition.

15. The method according to claim 12,
characterized in that, before, during or after machining of the surface, at least one machining and/or process parameter, an electrical voltage applied between the electrode (6) and the surface (2) to be machined, an intensity of a current flowing between the electrode (6) and the surface (2) to be machined, a distance between the application unit (4) and/or an outlet opening (10) of the application unit (4) and the workpiece surface (2), the supply with electrolytes, a movement of the workpiece (3), a movement of the application unit (4) and/or at least one setting of an emitter, using which, at least at times, sound waves and/or electromagnetic waves are coupled into at least one of the electrolyte jets, is measured and/or adjusted.
